(19) United States
(12) Patent Application Publication
(10) Pub. No.: US 2008/0110663 A1
(43) Pub. Date: May 15, 2008

(54) Communications Cable-Flame Retardant Separator

(76) Inventors: Jinder Jow, Singapore (SG); Jeffrey M. Cogen, Flemington, NJ (US)

Correspondence Address: The Dow Chemical Company, Intellectual Property Section, P.O. Box 1967, Midland, MI, 48641-1967, US

(21) Appl. No.: 11/659,580

(22) PCT Filed: Aug. 19, 2005
(86) PCT No.: PCT/US05/29512

§ 371 Date: Oct. 24, 2007

Related U.S. Application Data
(60) Provisional application No. 60/603,588, filed on Aug. 23, 2004.

(51) Int. Cl. H01B 7/295; H01B 11/02

(52) U.S. Cl. 174/113 C

(57) ABSTRACT

The present invention is a communication cable comprising a plurality of twisted pair conductors, a separator, and a communication cable jacket enclosing the plurality of twisted pair conductors and the separator. The communication cable passes the requirements of NFPA-262. In particular, the separator is polyolefin-based and achieves the desired electrical and flame retardant properties. The present invention is also a method for selecting a composition for preparing the separator and a method for preparing a communications cable therefrom.

This invention relates to a communications cable designed to achieve the requirements of National Fire Protection Association 262: Standard Method of Test for Flame Travel and Smoke of Wires and Cables for Use in Air-Handling Spaces, 2002 Edition (“NFPA-262”). In particular, the present invention relates to selecting polyolefin-based compositions for use in preparing flame retardant separators for communications cables.

Generally, cables must be flame retardant for use in enclosed spaces, such as automobiles, ships, buildings, and industrial plants. Likewise, communications cables must meet certain flame retardant performance. The flame retardant performance of communication cables depends upon the materials selected for preparing the jacket, the twisted pairs of insulated conductors, and the separator.

In building designs, communications cables must resist the spread of flame and the generation of and spread of smoke throughout a building in case of an outbreak of fire. Cables intended for installations in the air handling spaces of buildings are specifically required to pass the flame test specified by Underwriters Laboratories Inc. (UL), UL-910, or its Canadian Standards Association (CSA) equivalent, the FT6. The UL-910 and the FT6 represent the top of the fire rating hierarchy established by the NEC and CEC respectively. UL-910 is equivalent to NFPA-262.

Conventional designs of data grade telecommunication cable for installations in plenum chambers have a low smoke generating jacket material, e.g. of a specially filled PVC formulation or a fluoropolymer material, surrounding a core of twisted conductor pairs, each conductor individually insulated with a fluorinated insulation layer. The solid core of these communications cable contributes a large volume of fuel to a potential cable fire. Forming the core of a fire resistant material, such as with fluorinated perfluoroethylene polypropylene (FEP), is very costly due to the volume of material used in the core.

While U.S. Pat. No. 6,639,152 contends that solid flame retardant/smoke suppressed polyolefins may be used in connection with fluorinated polymers, the '152 patent notes that commercially available solid flame retardant/smoke suppressed polyolefin compounds exhibit inferior resistance to burning and generally produce more smoke than FEP under burning conditions. Similarly, U.S. Pat. Nos. 5,789,711 and 6,222,130 and published patent application No. US2001/0001426 postulate that copolymers may be used for making the separator to achieve the desired properties, but none discloses potential copolymers or how to select those copolymers.

Additionally, U.S. Pat. No. 5,969,295 and European Patent Application No. EP 1 162 632 indicate that suitable materials for the separator are polyvinylchloride, polyvinylchloride alloys, polyethylene, polypropylene, and flame retardant materials such as fluorinated polymers, yet, like the previously mentioned disclosures, they fail to teach which polyolefinic materials would yield the desired flame retardant and smoke control properties.

U.S. Pat. No. 6,150,612 indicates that it is not desirable for the separator to have a dielectric constant greater than 3.5 in the frequency range from 1 MHz to 400 MHz and describes a separator comprising flame retardant polyethylene (FRPE) having a dielectric constant of 2.5 and a loss factor of 0.001. Additionally, the '612 patent discloses that polyfluoroalkoxy (PFA), TFE/Perfluoromethylvinylether (MFA), ethylene chlorotrifluoroethylene (CTFE), polyvinyl chloride (PVC), FEP, and flame retardant polypropylene (FRPP) may be suitable materials for achieving the electrical properties of the separator.

While highlighting appropriate electrical properties for the separator, the '612 patent does not describe the appropriate flame retardant or smoke control properties of the separator or teach which, if any, polyolefinic materials can achieve the desired flame retardant properties. Instead, the '612 patent focuses on ensuring that the jacket achieve the desired electrical properties.

Interestingly, U.S. Pat. No. 6,074,503 recognizes the difficulty in identifying polyolefins that achieve fire safety requirements for plenum applications. The '503 patent discloses that, for plenum applications, the core should be formed from a solid low dielectric constant fluoropolymer, e.g., ethylene chlortrifluoroethylene (E-CTFE) or fluorinated ethylene propylene (FEP), a foamed fluoropolymer, e.g., foamed FEP, or polyvinyl chloride (PVC) in either solid, low dielectric constant form or foamed. The '503 patent observes that solid or foamed flame retardant polyolefin or similar materials are suitable for non-plenum applications.

There is a need for a low-cost separator composition which satisfies both the electrical and flame retardant requirements of communications cables in plenum applications. More specifically, there is a need for a polyolefin-based composition which satisfies those requirements.

There is also a need for a method for evaluating and selecting polyolefin-based compositions for use as separator compositions. Specifically, there is a need for the method to correlate the flame retardant performance of a separator composition to the resulting separator's contribution to the overall communications cable flame retardant performance in the NFPA-262 test.

The present invention is a communication cable comprising a plurality of twisted pair conductors, a separator, and a communication cable jacket enclosing the plurality of twisted pair conductors and the separator. The communication cable passes the requirements of NFPA-262. In particular, the separator is polyolefin-based and achieves the desired electrical and flame retardant properties.

The present invention is also a method for selecting a composition for preparing the separator and a method for preparing a communications cable therefrom.

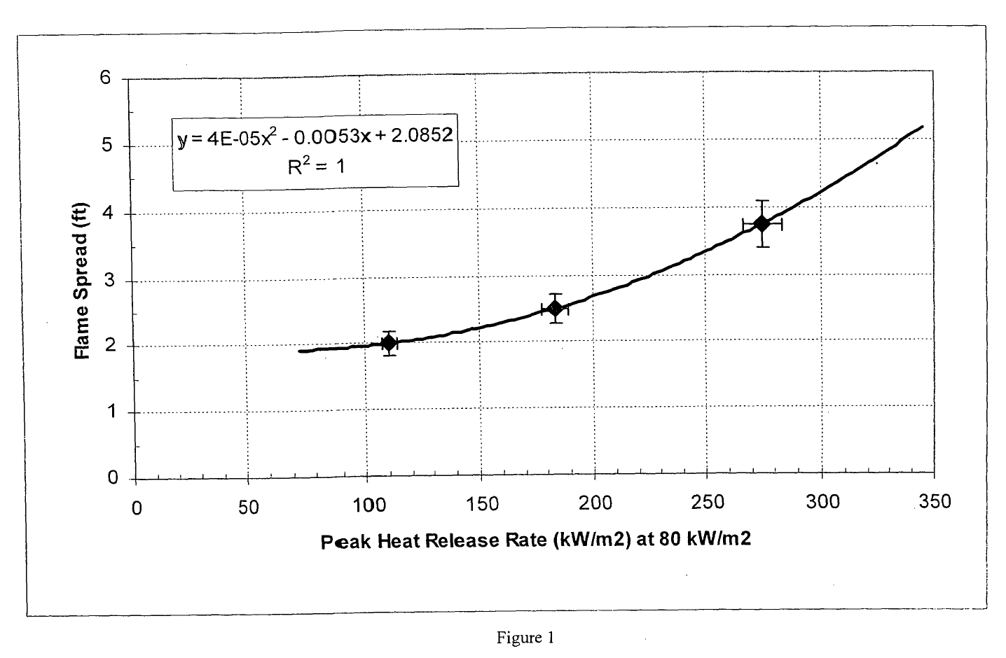

FIG. 1 shows the correlation between flame spread in NFPA-262 for cables containing various separator compounds and peak heat release rates obtained using cone calorimetry for the separator compounds.

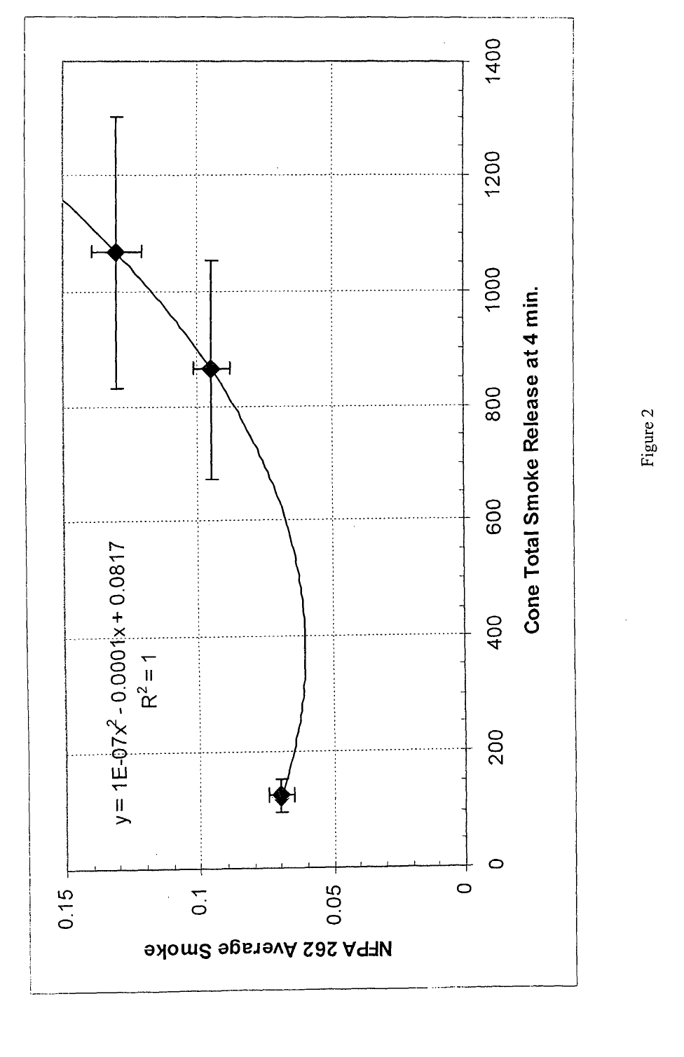

FIG. 2 shows the correlation between peak smoke density in NFPA-262 for cables containing various separator compounds and total smoke released within the first 4 minutes obtained using cone calorimetry for the separator compounds.

The invented communication cable comprises a plurality of twisted pair conductors, a separator, and a communication cable jacket enclosing the plurality of twisted pair conductors and the separator. The communication cable passes the requirements of NFPA-262.

Each of the twisted pair conductors include a pair of individually insulated metal conductors that are twisted together to form one of the plurality of twisted pair conductors. The conductor may be a metallic wire or any of the well-known metallic conductors used in wire and cable applications, such as copper, aluminum, copper-clad aluminum, and copper-clad steel. The twisted wires are surrounded by a layer of insulating material. Preferably, the thickness of the insulating material is less than about 25 mil, preferably less than about 15 mil, and for certain applications even less than about 10 mil.

Suitable insulating materials for the twisted wires include flame retardant (FR) polyethylene, polypropylene, and flame retardant materials such as fluorinated polymers. Preferably, the insulating material is a perfluorinated ethylene polypropylene copolymer.

The separator is prepared from a separator composition comprising a polyolefin and a flame retardant. The separator has a peak heat release rate (PHRR) less than about 330 kW/m², preferably less than 300 kW/m². Also, the separator has a total smoke released (TSR) of less than about 1150 m²/m², preferably less than 700 m²/m², and more preferably less than about 350 m²/m². The separator should have a time to peak heat release (TTPHRR) of greater than about 75 seconds, preferably greater than about 95 seconds, and more preferably greater than about 115 seconds. Additionally, the separator should have a time to ignition (TTI) of greater than about 20 seconds, preferably greater than about 25 seconds. These flame retardant and smoke properties are measured using cone calorimetry with a heat flux of 80 kW/m² and a sample thickness of 1.3 mm, with grid.

Physically, the separator is constructed such that it has a plurality of outwardly protruding projections angularly spaced about a core. The plurality of outwardly protruding projections protrude radially from the core and define regions between adjacent ones of the outwardly protruding projections within each of which one of the plurality of twisted pair conductors is contained.

The electrical properties of the separator are such that it has a dielectric constant less than or equal to about 3.3 measured at 1 MHz and a dissipation factor less than or equal to about 0.006.

Polyolefin polymers suitable for the separator composition include ethylene polymers, propylene polymers, and blends thereof. Preferably, the polyolefin polymers are substantially halogen-free. The selection of the polyolefin and its related flame retardants is necessary to achieving a good balance of physical, electrical, and rheological properties.

Ethylene polymer, as that term is used herein, is a homopolymer of ethylene or a copolymer of ethylene and a minor proportion of one or more alpha-olefins having 3 to 12 carbon atoms, and preferably 4 to 8 carbon atoms, and, optionally, a diene, or a mixture or blend of such homopolymers and copolymers. The mixture can be a mechanical blend or an in situ blend. Examples of the alpha-olefins are propylene, 1-butene, 1-hexene, 4-methyl-1-pentene, and 1-octene. The polyethylene can also be a copolymer of ethylene and an unsaturated ester such as a vinyl ester (for example, vinyl acetate or an acrylic or methacrylic acid ester), a copolymer of ethylene and an unsaturated acid such as acrylic acid, or a copolymer of ethylene and a vinyl silane (for example, vinyltrimethoxysilane and vinyltriethoxysilane).

The polyethylene can be homogeneous or heterogeneous. The homogeneous polyethylenes usually have a polydispersity (Mw/Mn) in the-range of 1.5 to 3.5 and an essentially uniform comonomer distribution, and are characterized by a single and relatively low melting point as measured by a differential scanning calorimeter. The heterogeneous polyethylenes usually have a polydispersity (Mw/Mn) greater than 3.5 and lack a uniform comonomer distribution. Mw is defined as weight average molecular weight, and Mn is defined as number average molecular weight.

The polyethylenes can have a density in the range of 0.860 to 0.960 gram per cubic centimeter, and preferably have a density in the range of 0.870 to 0.955 gram per cubic centimeter. They also can have a melt index in the range of 0.1 to 50 grams per 10 minutes. If the polyethylene is a homopolymer, its melt index is preferably in the range of 0.75 to 3 grams per 10 minutes. Melt index is determined under ASTM D-1238, Condition E and measured at 190 degree C. and 2160 grams.

Low- or high-pressure processes can produce the polyethylenes. They can be produced in gas phase processes or in liquid phase processes (that is, solution or slurry processes) by conventional techniques. Low-pressure processes are typically run at pressures below 1000 pounds per square inch (“psi”) whereas high-pressure processes are typically run at pressures above 15,000 psi.

Typical catalyst systems for preparing these polyethylenes include magnesium/titanium-based catalyst systems, vanadium-based catalyst systems, chromium-based catalyst systems, metallocene catalyst systems, and other transition metal catalyst systems. Many of these catalyst systems are often referred to as Ziegler-Natta catalyst systems or Phillips catalyst systems. Useful catalyst systems include catalysts using chromium or molybdenum oxides on silica-alumina supports.

Useful polyethylenes include low density homopolymers of ethylene made by high pressure processes (HP-LDPEs), linear low density polyethylenes (LLDPEs), very low density polyethylenes (VLDPEs), ultra low density polyethylenes (ULDPEs), medium density polyethylenes (MDPEs), high density polyethylene (HDPE), and metallocene copolymers.

High-pressure processes are typically free radical initiated polymerizations and conducted in a tubular reactor or a stirred autoclave. In the tubular reactor, the pressure is within the range of 25,000 to 45,000 psi and the temperature is in the range of 200 to 350 degree C. In the stirred autoclave, the pressure is in the range of 10,000 to 30,000 psi and the temperature is in the range of 175 to 250 degree C.

Copolymers comprised of ethylene and unsaturated esters or acids are well known and can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of 5 to 50 percent by weight based on the weight of the copolymer. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. Examples of the unsaturated acids include acrylic acids or maleic acids.

The melt index of the ethylene/unsaturated ester copolymers or ethylene/unsaturated acid copolymers can be in the range of 0.5 to 50 grams per 10 minutes, and is preferably in the range of 2 to 25 grams per 10 minutes.

Copolymers of ethylene and vinyl silanes may also be used. Examples of suitable silanes are vinyltrimethoxysilane and vinyltriethoxysilane. Such polymers are typically made using a high-pressure process. Use of such ethylene vinylsilane copolymers is desirable when a moisture crosslinkable composition is desired. Optionally, a moisture crosslinkable composition can be obtained by using a polyethylene grafted with a vinylsilane in the presence of a free radical initiator. When a silane-containing polyethylene is used, it may also be desirable to include a crosslinking catalyst in the formulation (such as dibutyltindilaurate or dodecylbenzenesulfonic acid) or another Lewis or Bronsted acid or base catalyst.

The VLDPE or ULDPE can be a copolymer of ethylene and one or more alpha-olefins having 3 to 12 carbon atoms and preferably 3 to 8 carbon atoms. The density of the VLDPE or ULDPE can be in the range of 0.870 to 0.915 gram per cubic centimeter. The melt index of the VLDPE or ULDPE can be in the range of 0.1 to 20 grams per 10 minutes and is preferably in the range of 0.3 to 5 grams per 10 minutes. The portion of the VLDPE or ULDPE attributed to the comonomer(s), other than ethylene, can be in the range of 1 to 49 percent by weight based on the weight of the copolymer and is preferably in the range of 15 to 40 percent by weight.

A third comonomer can be included, for example, another alpha-olefin or a diene such as ethylidene norbornene, butadiene, 1,4-hexadiene, or a dicyclopentadiene. Ethylene/propylene copolymers are generally referred to as EPRs and ethylene/propylene/diene terpolymers are generally referred to as an EPDM. The third comonomer can be present in an amount of 1 to 15 percent by weight based on the weight of the copolymer and is preferably present in an amount of 1 to 10 percent by weight. It is preferred that the copolymer contains two or three comonomers inclusive of ethylene.

The LLDPE can include VLDPE, ULDPE, and MDPE, which are also linear, but, generally, has a density in the range of 0.916 to 0.925 gram per cubic centimeter. It can be a copolymer of ethylene and one or more alpha-olefins having 3 to 12 carbon atoms, and preferably 3 to 8 carbon atoms. The melt index can be in the range of 1 to 20 grams per 10 minutes, and is preferably in the range of 3 to 8 grams per 10 minutes.

Any polypropylene may be used in these compositions. Examples include homopolymers of propylene, copolymers of propylene and other olefins, and terpolymers of propylene, ethylene, and dienes (for example, norbornadiene and decadiene). Additionally, the polypropylenes may be dispersed or blended with other polymers such as EPR or EPDM. Examples of polypropylenes are described in POLYPROPYLENE HANDBOOK: POLYMERIZATION, CHARACTERIZATION, PROPERTIES, PROCESSING, APPLICATIONS 3-14, 113-176 (E. Moore, Jr. ed., 1996).

Suitable polypropylenes may be components of TPEs, TPOs and TPVs. Those polypropylene-containing TPEs, TPOs, and TPVs can be used in this application.

Suitable flame retardants include metal hydroxides and phosphates. Preferably, suitable metal hydroxide compounds include aluminum trihydroxide (also known as ATH or aluminum trihydrate) and magnesium hydroxide (also known as magnesium dihydroxide). Other flame-retarding metal hydroxides are known to persons of ordinary skill in the art. The use of those metal hydroxides is considered within the scope of the present invention.

The surface of the metal hydroxide may be coated with one or more materials, including silanes, titanates, zirconates, carboxylic acids, and maleic anhydride-grafted polymers. Suitable coatings include those disclosed in U.S. Pat. No. 6,500,882. The average particle size may range from less than 0.1 micrometers to 50 micrometers. In some cases, it may be desirable to use a metal hydroxide having a nano-scale particle size. The metal hydroxide may be naturally occurring or synthetic.

Preferred phosphates include ethylene diamine phosphate, melamine phosphate, melamine pyrophosphate, melamine polyphosphate, and ammonium polyphosphate.

The separator composition may contain other flame-retardant additives. Other suitable non-halogenated flame retardant additives include red phosphorus, silica, alumina, titanium oxides, carbon nanotubes, talc, clay, organo-modified clay, silicone polymer, calcium carbonate, zinc borate, antimony trioxide, wollastonite, mica, hindered amine stabilizers, ammonium octamolybdate, melamine octamolybdate, frits, hollow glass microspheres, intumescent compounds, and expandable graphite. Preferably, silicone polymer is an additional flame retardant additive. Suitable halogenated flame retardant additives include decabromodiphenyl oxide, decabromodiphenyl ethane, ethylene-bis (tetrabromophthalimide), and dechlorane plus.

In addition, the separator composition may contain a nanoclay. Preferably, the nano-clay having at least one dimension in the 0.9 to 200 nanometer-size range, more preferably at least one dimension in the 0.9 to 150 nanometers, even more preferably 0.9 to 100 nanometers, and most preferably 0.9 to 30 nanometers.

Preferably, the nanoclays are layered, including nanoclays such as montmorillonite, magadiite, fluorinated synthetic mica, saponite, fluorhectorite, laponite, sepiolite, attapulgite, hectorite, beidellite, vermiculite, kaolinite, nontronite, volkonskoite, stevensite, pyrosite, sauconite, and kenyaite. The layered nanoclays may be naturally occurring or synthetic.

Some of the cations (for example, sodium ions) of the nanoclay can be exchanged with an organic cation, by treating the nanoclay with an organic cation-containing compound. Alternatively, the cation can include or be replaced with a hydrogen ion (proton). Preferred exchange cations are imidazolium, phosphonium, ammonium, alkyl ammonium, and polyalkyl ammonium. An example of a suitable ammonium compound is dimethyl, di(hydrogenated tallow) ammonium. Preferably, the cationic coating will be present in 15 to 50% by weight, based on the total weight of layered nanoclay plus cationic coating. In the most preferred embodiment, the cationic coating will be present at greater than 30% by weight, based on the total weight of layered nanoclay plus cationic coating. Another preferred ammonium coating is octadecyl ammonium.

The composition may contain a coupling agent to improve the compatibility between the polyolefin polymer and the nanoclay. Examples of coupling agents include silanes, titanates, zirconates, and various polymers grafted with maleic anhydride. Other coupling technology would be readily apparent to persons of ordinary skill in the art and is considered within the scope of this invention.

In addition, the separator composition may contain other additives such as antioxidants, stabilizers, blowing agents, carbon black, pigments, processing aids, peroxides, cure boosters, and surface active agents to treat fillers may be present. Furthermore, the separator composition may be thermoplastic or crosslinked.

The jacket is made of a flexible polymer material and is preferably formed by melt extrusion. Preferable polymers include polyvinylchloride, fluoropolymers, and flame retardant polyolefins. Preferably, the jacket is extruded to a thickness of between 15 and 25 mils to allow the jacket to be easily stripped from the twisted pairs of insulated conductors.

In an alternate embodiment, the present invention is a method for preparing a NFPA-262 communication cable comprising the steps of (a) selecting a separator composition, (b) preparing a plurality of twisted pair conductors, (c) preparing a separator having a plurality of outwardly protruding projections from the separator composition, (d) separating the plurality of twisted pair conductors by the plurality of outwardly protruding projections of the separator, and (e) enclosing with a communication cable jacket the plurality of twisted pair conductors separated by the plurality of outwardly protruding projections of the separator

### EXAMPLES

The following non-limiting examples illustrate the invention.

### Separator Compositions

### Examples 1 and 2

Two polyolefin-based separator compositions were prepared for determination of flame retardant, smoke, physical, and electrical properties. The components used in preparing the compositions and their amounts are shown in Table I.

The peak heat release rate and total smoke were measured using cone calorimetry with a heat flux of 80 kW/m² and a sample thickness of 1.3 mm with grid according to ASTM E1354/ISO 5660. The tensile strength and elongation were measured according to ASTM D638. Dielectric constant and dissipation factor were measured according to ASTM D150.

TABLE I

| Components | Example 1 | Example 2 |
|---|---|---|
| Affinity ™ EG-8200 polyethylene | 23.9 | 13.4 |
| Attane ™ 4404G ultra low density polyethylene | | 13.4 |
| DGDL-3364 polyethylene | 23.9 | |
| Amplify ™ GR-208 VLDPE ethylene/ | | 6.0 |
| butene copolymer | | |
| Irganox 1010FF ™ tetrakis [methylene | 0.2 | 0.2 |
| (3,5-di-tert-butyl-4-hydroxyhydro-cinnamate)] | | |
| methane | | |
| Intumax AC3 ethylene diamine phosphate with | 52.0 | |
| a char catalyst | | |
| ethylene-bis (tetrabromophthalimide) | | 18.0 |
| Magnesium hydroxide | | 35.0 |
| Zinc borate | | 5.0 |
| FZ-16 frit | | 5.0 |
| DC 4-7081 silicone gum | | 4.0 |

Properties

| | | |
|---|---|---|
| Peak heat release rate (kW/m²) | 275 | 183 |
| Total smoke released (m²/m²) | 883 | 1064 |
| Dielectric constant at 1 MHz | 3.2 | 3.1 |
| Dissipation factor at 1 MHz | 0.0005 | 0.001 |
| Tensile Strength (psi) | 856 | 1457 |
| Elongation, % | 595 | 192 |
| Density (g/cc) | 1.15 | 1.52 |

Affinity™ EG-8200 polyethylene is commercially available from The Dow Chemical Company with a melt index of 5.0 grams/10 minutes, a density 0.87 grams/cubic centimeter, and a polydispersity index of less than 3. Attane™ 4404G ultra low density polyethylene is commercially available from The Dow Chemical Company and has density of 0.9 g/cc and a melt index of 4.0. DGDL-3364 is an ethylene hexane copolymer having a density of 0.95 grams per cubic centimeter and a melt index of 0.85 grams per 10 minutes, which is commercially available from The Dow Chemical Company. Amplify™ GR-208 is a very low density ethylene/butene copolymer, having a 0.3 weight percent maleic anhydride graft, a density of 0.899 grams/cubic-centimeters, and a melt index of 3.3 grams/10 minutes, which is commercially available from The Dow Chemical Company.

Irganox 1010 is available from Ciba Specialty Chemicals Inc. Intumax AC3 is available from Broadview Technologies Inc. FZ-16 is available from Fusion Ceramics Inc. DC 4-7081 is available from Dow Corning Corporation and described as a powdered siloxane with methacrylate functionality.

### Separator Compositions in Communication Cables

### Examples 1 and 2

The exemplified compositions of Examples 1 and 2 were also used to prepare star separators for communications cables. The cables contained fluorinated perfluoroethylene polypropylene (FEP) insulations over four pairs of copper conductors. Each jacket of the cables was made from a low smoke polyvinyl chloride compound. A comparative cable was prepared using an FEP composition as the star separator composition. The cables were evaluated according to the burn test of NFPA-262. The cables containing the exemplified compositions passed the flame spread and average smoke portion of the NFPA-262 test.

The cone calorimetry results and NFPA-262 tests were correlated and used to estimate the cone calorimetry performance needed to meet the flame spread and average smoke requirements of NFPA-262. FIGS. 1 and 2 show the results and the predictive models.

Accordingly, separator compounds, having peak heat release less than about 330 kW/m2 and total smoke released by 4 minutes of less than about 1150 m2/m2, can enable a communications cable to pass the flame spread and average smoke requirements of NFPA-262, provided the other components (i.e., jacket and insulated twisted pair conductors) of the communications cable are also selected to pass the NFPA-262 test requirements.

### Separator Compositions

### Examples 3-6

Four polyolefin-based separator compositions were prepared for determination of flame retardant and smoke properties. The components used in preparing the compositions and their amounts are shown in Table II. The properties were measured using cone calorimetry with a heat flux of 80 kW/m² and a sample thickness of 1.3 mm with grid according to ASTM E1354/ISO 5660.

Cone calorimetry results are listed in Table II (peak heat release rate, total smoke released, time to peak heat release rate, and time to ignition.) Additionally, plenum cables were fabricated using these materials as star separator compositions, and the cables were testing according to NFPA-262. The results are listed in Table II (flame spread, peak optical density, and average optical density.)

Table II also recites the dielectric constant and dissipation factor both at 1 MHz for Example 3; it is anticipated that Examples 4-6 would have the same values.

TABLE II

| Components | Ex. 3 | Ex. 4 | Ex. 5 | Ex. 6 |
|---|---|---|---|---|
| Affinity ™ EG-8200 polyethylene | 13.3 | 13.3 | 13.3 | 13.3 |
| DEFA-1373 NT VLDPE | 6 | 6 | 6 | 6 |
| ethylene/butene copolymer | | | | |
| Irganox 1010FF ™ tetrakis | 0.2 | 0.2 | 0.2 | 0.2 |
| [methylene (3,5-di-tert-butyl-4- | | | | |
| hydroxyhydro-cinnamate)] | | | | |
| methane | | | | |
| Kisuma 5B-1G magnesium | 65 | | | |
| hydroxide | | | | |
| Magnifin H10MV magnesium | | 65 | | |
| hydroxide | | | | |
| Magnifin H7C2 magnesium | | | 65 | 60 |
| hydroxide | | | | |
| Nanoblend 3100 nanoclay | 12.5 | 12.5 | 12.5 | 12.5 |
| masterbatch (40%) | | | | |
| MB 50-002 polydimethylsiloxane/ | 3 | 3 | 3 | 3 |
| low density polyethylene | | | | |
| masterbatch | | | | |
| 3M Scotchlite S60/10,000 hollow | | | | 5 |
| glass microspheres | | | | |
| Estimated Density (g/cc) | 1.567 | 1.567 | 1.567 | 1.428 |

Properties

| | | | | |
|---|---|---|---|---|
| Flame spread (ft) | 1.8 | 2.0 | 2.3 | 2.0 |
| Peak optical density | 0.37 | 0.37 | 0.41 | 0.31 |
| Average optical density | 0.11 | 0.11 | 0.12 | 0.11 |
| peak heat release rate (kW/m²) | 205 | 282 | 235 | 284 |
| total smoke released (m²/m²) | 293 | 313 | 319 | 308 |
| time to peak heat release rate (sec) | 100 | 135 | 135 | 125 |
| time to ignition (sec) | 29 | 28 | 28 | 25 |
| Dielectric constant at 1 MHz | 3.3 | | | |
| Dissipation factor at 1 MHz | 0.004 | | | |

Kisuma 5B-1G magnesium hydroxide is available from Kyowa Chemicals, has a surface area of 6.1 m²/g (as determined by the BET method) and an average particle size of 0.8 microns (800 nanometers), and contains a fatty-acid surface treatment.

Both Magnifin H10MV magnesium hydroxide and H7C2 magnesium hydroxide are available from Albemarle Corporation. H10MV magnesium hydroxide is a surface-treated material with a surface area of about 10 m²/g (as determined by the BET method) and an average particle size of 0.8 microns (800 nanometers). H7C2 magnesium hydroxide is a stearic acid-treated material with a surface area of 6 m²/g (as determined by the BET method) and an average particle size of 0.9 microns (900 nanometers).

Nanoblend 3100 nanoclay masterbatch (40%) is available from PolyOne Corporation. MB 50-002™ Masterbatch is a 50:50 ultra high molecular weight polydimethylsiloxane/low density polyethylene masterbatch available from Dow Corning Corporation.

What is claimed is:

1. A communication cable comprising:
a. a plurality of twisted pair conductors, each of the twisted pair conductors including a pair of individually insulated metal conductors that are twisted together to form one of the plurality of twisted pair conductors;
b. a separator
(i) being prepared from a separator composition
(1) comprising
(A1) a polyolefin and
(A2) a flame retardant and
(2) having a peak heat release rate (PHRR) less than about 330 kW/m², a total smoke released (TSR) of less than about 1150 m²/m², a time to peak heat release (TTPHRR) of greater than about 75 seconds, and a time to ignition (TTI) of greater than about 20 seconds when measured using cone calorimetry with a heat flux of 80 kW/m² and a sample thickness of 1.3 mm and
(ii) having
(1) a plurality of outwardly protruding projections angularly spaced about a core, the plurality of outwardly protruding projections protruding radially from the core and defining regions between adjacent ones of the outwardly protruding projections within each of which one of the plurality of twisted pair conductors is contained,
(2) a dielectric constant less than or equal to about 3.3 measured at 1 MHz, and
(3) a dissipation factor less than or equal to about 0.006; and
c. a communication cable jacket enclosing the plurality of twisted pair conductors separated by the plurality of outwardly protruding projections of the separator,
wherein the communication cable passes the requirements of NFPA-262.

2. The communication cable of claim 1 wherein the polyolefin of the separator composition being substantially halogen free.

3. The communication cable of claim 1 wherein the flame retardant being selected from the group consisting metal hydroxides and phosphates.

4. The communication cable of claim 3 wherein the flame retardant being a phosphate selected from the group consisting of ethylene diamine phosphate, melamine phosphate, melamine pyrophosphate, melamine polyphosphate, and ammonium polyphosphate.

5. The communication cable of claim 1 wherein the separator composition further comprises a silicon polymer.

6. The communication cable of claim 1 wherein the separator composition further comprises a nanoclay.

7. The communication cable of claim 1 wherein the insulation of the insulated metal conductors comprises perfluorinated ethylene polypropylene copolymer.

8. The communication cable of claim 1 wherein the communication cable jacket being prepared from a jacketing composition comprising a polymer selected from the group consisting of polyvinyl chloride, fluoropolymers, and flame retardant polyolefins.

9. A method for preparing a NFPA-262 communication cable comprising the steps of:
a. selecting a separator composition
(i) comprising a polyolefin and a flame retardant and
(ii) having a peak heat release rate (PHRR) less than about 330 kW/m², a total smoke released (TSR) of less than about 1150 m²/m², a time to peak heat release (TTPHRR) of greater than about 75 seconds, and a time to ignition (TTI) of greater than about 20 seconds when measured using cone calorimetry with a heat flux of 80 kW/m² and a sample thickness of 1.3 mm;
b. preparing a plurality of twisted pair conductors, each of the twisted pair conductors including a pair of individually insulated metal conductors that are twisted together to form one of the plurality of twisted pair conductors;
c. preparing a separator, from the separator composition, having
(1) a plurality of outwardly protruding projections angularly spaced about a core, the plurality of outwardly protruding projections protruding radially from the core and defining regions between adjacent ones of the outwardly protruding projections within each of which one of the plurality of twisted pair conductors is contained,
(2) a dielectric constant less than or equal to about 3.3 measured at 1 MHz, and
(3) a dissipation factor less than or equal to about 0.006; and
d. separating the plurality of twisted pair conductors by the plurality of outwardly protruding projections of the separator, and
e. enclosing with a communication cable jacket the plurality of twisted pair conductors separated by the plurality of outwardly protruding projections of the separator.
